(19) United States
(12) Patent Application Publication
(10) Pub. No.: US 2021/0166111 A1
(43) Pub. Date: Jun. 3, 2021

(54) Systems and Methods of Training Processing Engines

(71) Applicant: doc.ai, Inc., Palo Alto, CA (US)

(72) Inventors: James Douglas Knighton, JR., Sunnyvale, CA (US); Philip Joseph Dow, South Lake Tahoe, CA (US); Marina Titova, Menlo Park, CA (US); Srivatsa Akshay Sharma, Santa Clara, CA (US); Walter Adolf De Brouwer, Los Altos Hills, CA (US); Joel Thomas Kaardal, San Mateo, CA (US); Gabriel Gabra ZACCAK, Cambridge, MA (US); Salvatore VIVONA, Palo Alto, CA (US); Devin Daniel REICH, Olympia, WA (US)

(73) Assignee: doc.ai, Inc., Palo Alto, CA (US)

(21) Appl. No.: 17/109,118

(22) Filed: Dec. 1, 2020

Related U.S. Application Data
(60) Provisional application No. 62/942,644, filed on Dec. 2, 2019.

(51) Int. Cl. G06N 3/063; G06N 3/08; G06N 5/04; G06F 15/80

(52) U.S. Cl. CPC G06N 3/063; G06F 15/80; G06N 5/046; G06N 3/084

(57) ABSTRACT

The technology disclosed relates to a system and method for training processing engines. A processing engine can have at least a first processing module and a second processing module. The first processing module in each processing engine is different from a corresponding first processing module in every other processing engine. The second processing module in each processing engine is same as a corresponding second processing module in every other processing engine. The system can include a deployer that deploys each processing engine to a respective hardware module for training. The system can comprise a forward propagator which during forward pass stage can process inputs through first processing modules and produce an intermediate output for each first processing module. The system can comprise a backward propagator which during backward pass stage can determine gradients for each second processing module on corresponding final outputs and ground truths.

### PRIORITY APPLICATION

This application claims the benefit of U.S. Patent Application No. 62/942,644, entitled “SYSTEMS AND METHODS OF TRAINING PROCESSING ENGINES,” filed Dec. 2, 2019 (Attorney Docket No. DCAI 1002-1). The provisional application is incorporated by reference for all purposes.

### INCORPORATIONS

The following materials are incorporated by reference as if fully set forth herein:

U.S. Provisional Patent Application No. 62/883,639, titled “FEDERATED CLOUD LEARNING SYSTEM AND METHOD,” filed on Aug. 6, 2019 (Atty. Docket No. DCAI 1014-1);

U.S. Provisional Patent Application No. 62/816,880, titled “SYSTEM AND METHOD WITH FEDERATED LEARNING MODEL FOR MEDICAL RESEARCH APPLICATIONS,” filed on Mar. 11, 2019 (Atty. Docket No. DCAI 1008-1);

U.S. Provisional Patent Application No. 62/481,691, titled “A METHOD OF BODY MASS INDEX PREDICTION BASED ON SELFIE IMAGES,” filed on Apr. 5, 2017 (Atty. Docket No. DCAI 1006-1);

U.S. Provisional Patent Application No. 62/671,823, titled “SYSTEM AND METHOD FOR MEDICAL INFORMATION EXCHANGE ENABLED BY CRYPTO ASSET,” filed on May 15, 2018;

Chinese Patent Application No. 201910235758.60, titled “SYSTEM AND METHOD WITH FEDERATED LEARNING MODEL FOR MEDICAL RESEARCH APPLICATIONS,” filed on Mar. 27, 2019;

Japanese Patent Application No. 2019-097904, titled “SYSTEM AND METHOD WITH FEDERATED LEARNING MODEL FOR MEDICAL RESEARCH APPLICATIONS,” filed on May 24, 2019;

U.S. Nonprovisional patent application Ser. No. 15/946,629, titled “IMAGE-BASED SYSTEM AND METHOD FOR PREDICTING PHYSIOLOGICAL PARAMETERS,” filed on Apr. 5, 2018 (Atty. Docket No. DCAI 1006-2);

U.S. Nonprovisional patent application Ser. No. 16/816,153, titled “SYSTEM AND METHOD WITH FEDERATED LEARNING MODEL FOR MEDICAL RESEARCH APPLICATIONS,” filed on Mar. 11, 2020 (Atty. Docket No. DCAI 1008-2);

U.S. Nonprovisional patent application Ser. No. 16/987,279, titled “TENSOR EXCHANGE FOR FEDERATED CLOUD LEARNING,” filed on Aug. 6, 2020 (Atty. Docket No. DCAI 1014-2); and

U.S. Nonprovisional patent application Ser. No. 16/167,338, titled “SYSTEM AND METHOD FOR DISTRIBUTED RETRIEVAL OF PROFILE DATA AND RULE-BASED DISTRIBUTION ON A NETWORK TO MODELING NODES,” filed on Oct. 22, 2018.

### FIELD OF THE TECHNOLOGY DISCLOSED

The technology disclosed relates to use of machine learning techniques on distributed data using federated learning, more specifically the technology disclosed in which different data sources owned by different parties are used to train one machine learning model.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Insufficient data and labels can result in weak performance by machine learning models. In many applications such as healthcare, data related to same users or entities such as patients are maintained by separate departments in one organization or separate organizations resulting in data silos. A data silo is a situation in which only one group or department in an organization can access a data source. Raw data regarding the same users from multiple data sources cannot be combined due to privacy regulations and laws. Examples of different data sources can include health insurance data, medical claims data, mobility data, genomic data, environmental or exposomic data, laboratory tests and prescriptions data, trackers and bed side monitors data, etc. Therefore, raw data from different sources and owned by respective departments and organizations cannot be combined to train powerful machine learning models that can provide insights and predictions for providing better services and products to users.

An opportunity arises to train high performance machine learning models by utilizing different and heterogenous data sources without breaking the privacy regulations and laws.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

FIG. 1 is an architectural level schematic of a system that can apply a Federated Cloud Learning (FCL) Trainer to train processing engines.

FIG. 2 presents an implementation of the technology disclosed with multiple processing engines.

FIG. 3 presents an implementation of a forward propagator and combiner during forward pass stage of the training.

FIG. 4 presents an implementation of a backward propagator which determines gradients for second processing modules and a gradient accumulator during backward pass stage of the training.

FIG. 5 presents backward propagator which determines gradients for first processing modules and a weight updater which updates weights of first processing module during backward pass stage of training.

FIGS. 6A and 6B present examples of first processing modules and second processing modules.

FIGS. 7A-7C present some distributions of interest for an example use case of the technology disclosed.

FIG. 8 presents comparative results for the example use case.

FIG. 9A presents a high-level architecture of federated cloud learning (FCL) system.

FIG. 9B presents an example feature space for different systems in a FCL system with no feature overlap.

FIG. 10 presents a bus system and a memory access controller for FCL system.

FIG. 11 is a block diagram of a computer system that can be used to implement the technology disclosed.

### DETAILED DESCRIPTION

The following discussion is presented to enable any person skilled in the art to make and use the technology disclosed, and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

### INTRODUCTION

Traditionally, to take advantage of a dataset using machine learning, all the data for training had to be gathered to one place. However, as more of the world becomes digitized, this will fail to scale with the vast ecosystem of potential data sources that could augment machine learning (ML) models in ways limited only to the imagination. To solve this, we resort to federated learning (“FL”).

Federated learning approach aggregates model weights across multiple devices without such devices explicitly sharing their data. However, the horizontal federated learning assumes a shared feature space, with independently distributed samples stored on each device. Because of the true heterogeneity of information across devices, there can exist relevant information in different feature spaces. In many scenarios such as these, the input feature space is not aligned across devices, making it extremely difficult to relish from the benefits of horizontal FL. If the feature space is not aligned, this results in two specific types of Federated Learning; vertical and transfer. The technology disclosed incorporates vertical learning to enable machine learning models to learn across distributed data silos with different features representing the same set of users. FL is a set of techniques to perform machine learning on distributed data—data which may lie in highly different engineering, economic, and legal (e.g. privacy) landscapes. In the literature, it is mostly conceived as making use of entire samples found across a sea of devices (i.e. horizontally federated learning), that never leave their home device. The ML paradigm remains otherwise the same.

Federated Cloud Learning (“FCL”) is a vertical federated learning—a bigger perspective of FL in which different data sources, which are keyed to each other but owned by different parties, are used to train one model simultaneously, while maintaining the privacy of each component dataset from the others. That is, the samples are composed of parts that live in (and never leave) different places. Model instances only ever see a part of the entire sample, but perform comparably to having the entire feature space, due to the way the model stores its knowledge. This results in tight system coupling, but makes practical and practicable a pandora's box of system possibilities not seen before.

Vertical federated learning (VFL) is best applicable in settings where two or more data silos store a different set of features describing the same population, which will be hereafter referred to as the overlapping population (OP). Assuming the OP is sufficiently large for the specific learning task of interest, vertical federated learning is a viable option for securely aggregating different feature sets across multiple data silos.

Healthcare is one among many industries that can benefit from VFL. Users data is fragmented between different institutions/organizations and departments. Most of these organizations or departments will never be allowed to share their raw data due to privacy regulations and laws. Even if we have access to such data, the data is not homogenous and it cannot be combined directly into an one ML model and vertical federated learning is a better fit to deal with heterogeneous data since it trains a joint model on encoded embeddings. VFL can leverage the private datasets or data silos to learn a joint model. The joint model can learn a holistic view of the users and create a powerful feature space for each user which trains a more powerful model.

### Environment

Many alternative embodiments of the present aspects may be appropriate and are contemplated, including as described in these detailed embodiments, though also including alternatives that may not be expressly shown or described herein but as obvious variants or obviously contemplated according to one of ordinary skill based on reviewing the totality of this disclosure in combination with other available information. For example, it is contemplated that features shown and described with respect to one or more embodiments may also be included in combination with another embodiment even though not expressly shown and described in that specific combination.

For purpose of efficiency, reference numbers may be repeated between figures where they are intended to represent similar features between otherwise varied embodiments, though those features may also incorporate certain differences between embodiments if and to the extent specified as such or otherwise apparent to one of ordinary skill, such as differences clearly shown between them in the respective figures.

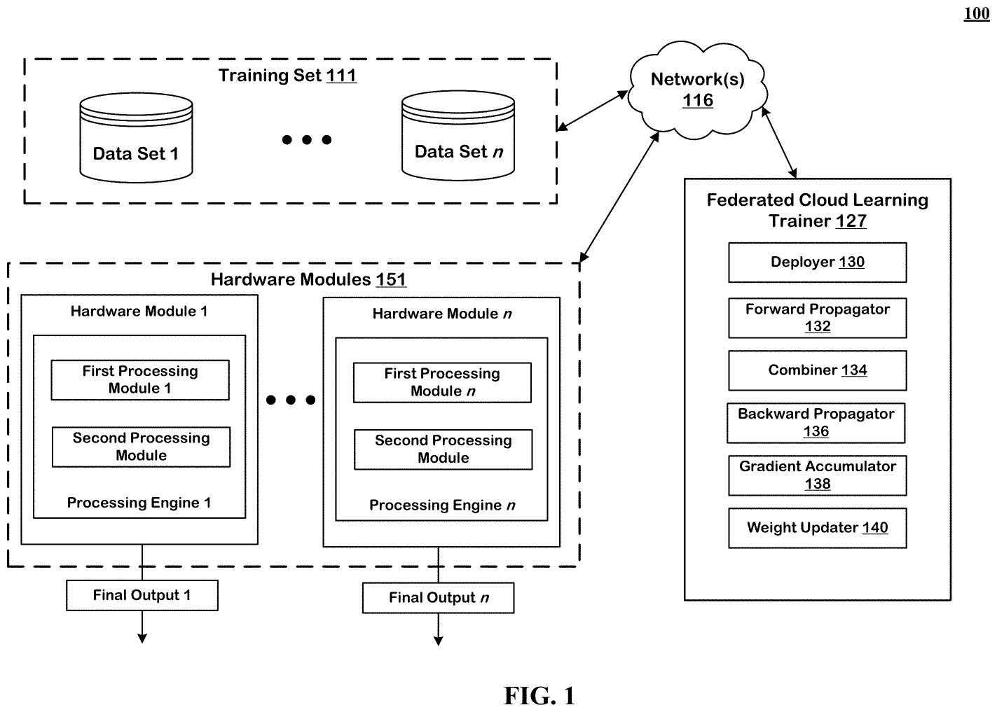

We describe a system 100 for Federated Cloud Learning (FCL). The system is described with reference to FIG. 1 showing an architectural level schematic of a system in accordance with an implementation. Because FIG. 1 is an architectural diagram, certain details are intentionally omitted to improve the clarity of the description. The discussion of FIG. 1 is organized as follows. First, the elements of the figure are described, followed by their interconnection. Then, the use of the elements in the system is described in greater detail.

FIG. 1 includes the system 100. This paragraph names labeled parts of system 100. The figure includes a training set 111, hardware modules 151, a vertical federated learning trainer 127, and a network(s) 116. The network(s) 116 couples the training set 111, hardware modules 151, and the vertical federated learning trainer (FLT) or federated cloud learning trainer (FCLT) 127. The training set 111 can comprise multiple datasets labeled as dataset 1 through dataset n. The datasets can contain data from different sources such as different departments in an organization or different organizations. The datasets can contain data related to same users or entities but separate fields. For example, in one training set, the datasets can contain data from different banks, in another example training set the datasets can contain data from different health insurance providers. In another example, the datasets can contain data for patients from different sources such as laboratories, pharmacies, health insurance providers, clinics or hospitals, etc. Due to privacy laws and regulations, the raw data from different datasets cannot be shared with entities outside the department or the organization who owns the data.

The hardware modules 151 can be computing devices or edge devices such as mobile computing devices or embedded computing systems, etc. The technology disclosed deploys a processing engine on a hardware module. For example, as shown in FIG. 1, the processing engine 1 is deployed on hardware module 1 and processing engine n is deployed on hardware module n. A processing engine can comprise of a first processing module and a second processing module. A final output is produced by the second processing module for respective processing engines.

A federated cloud learning (FCL) trainer 127 includes the components to train processing engines. The FCL trainer 127 includes a deployer 130, a forward propagator 132, a combiner 134, a backward propagator 136, a gradient accumulator 138, and a weight updater 140. We present details of the components of the FCL trainer in the following sections.

Completing the description of FIG. 1, the components of the system 100, described above, are all coupled in communication with the network(s) 116. The actual communication path can be point-to-point over public and/or private networks. The communications can occur over a variety of networks, e.g., private networks, VPN, MPLS circuit, or Internet, and can use appropriate application programming interfaces (APIs) and data interchange formats, e.g., Representational State Transfer (REST), JavaScript Object Notation (JSON), Extensible Markup Language (XML), Simple Object Access Protocol (SOAP), Java Message Service (JMS), and/or Java Platform Module System. All of the communications can be encrypted. The communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi and WiMAX. The engines or system components of FIG. 1 are implemented by software running on varying types of computing devices. Example devices are a workstation, a server, a computing cluster, a blade server, and a server farm. Additionally, a variety of authorization and authentication techniques, such as username/password, Open Authorization (OAuth), Kerberos, Secured, digital certificates and more, can be used to secure the communications.

### System Components

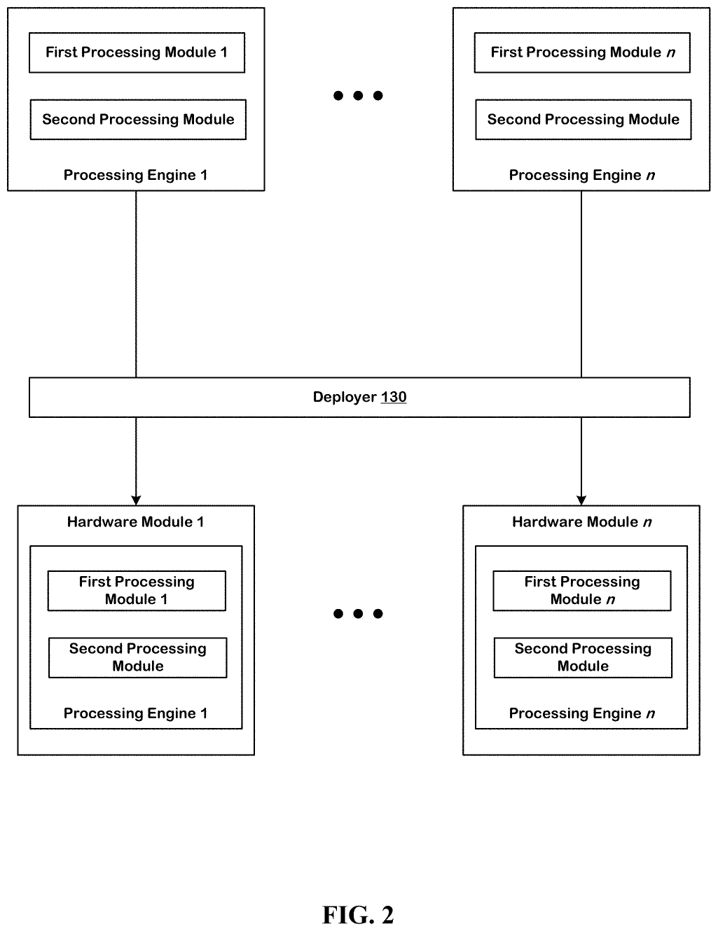

We present details of the components of the FCL trainer 127 in FIGS. 2 to 5. FIG. 2 illustrates one implementation of a plurality of processing engines. Each processing engine in the plurality of processing engines has at least a first processing module (or an encoder) and a second processing module (or a decoder). The first processing module in each processing engine is different from a corresponding first processing module in every other processing engine. The second processing module in each processing engine is same as a corresponding second processing module in every other processing engine. A deployer 130 deploys each processing engine to a respective hardware module in a plurality of hardware modules for training.

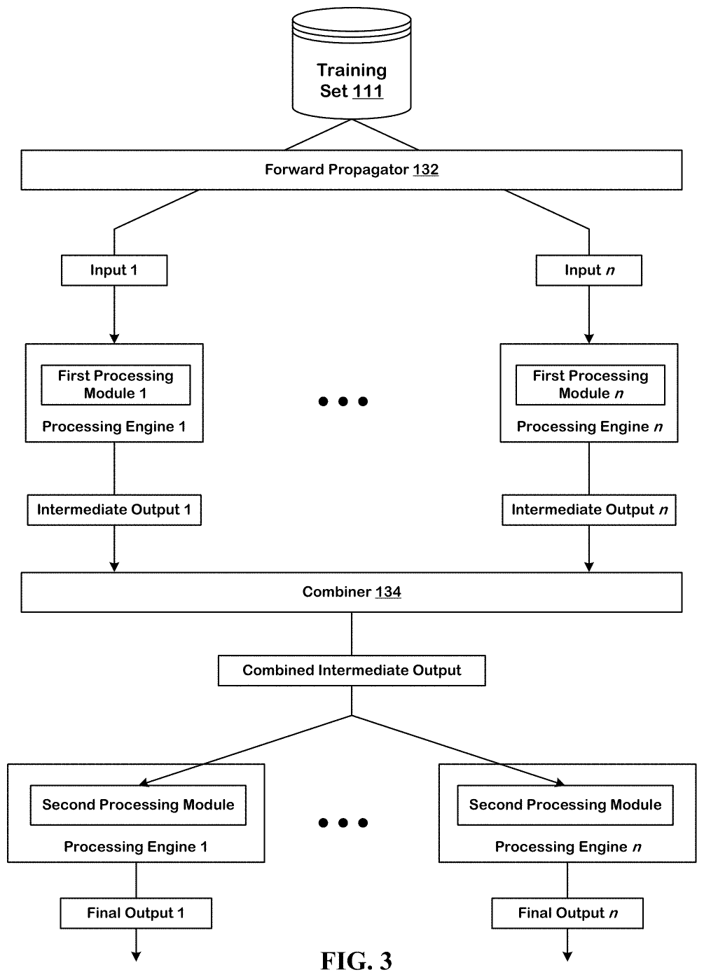

FIG. 3 shows one implementation of a forward propagator 132 which, during forward pass stage of the training, processes inputs through the first processing modules of the processing engines and produces an intermediate output for each first processing module. FIG. 3 also shows a combiner 134 which, during the forward pass stage of the training, combines intermediate outputs across the first processing modules and produces a combined intermediate output for each first processing module. The forward propagator 132, during the forward pass stage of the training, processes combined intermediate outputs through the second processing modules of the processing engines and produces a final output for each second processing module.

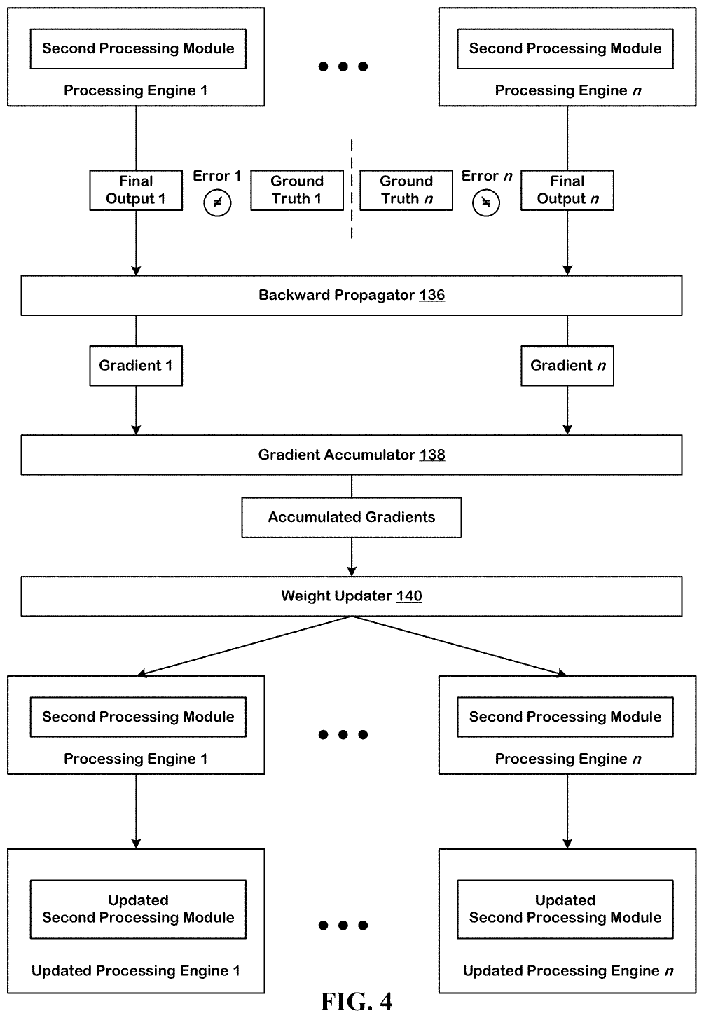

FIG. 4 shows one implementation of a backward propagator 136 which, during backward pass stage of the training, determines gradients for each second processing module based on corresponding final outputs and corresponding ground truths. FIG. 4 also shows a gradient accumulator 138 which, during the backward pass stage of the training, accumulates the gradients across the second processing modules and produces accumulated gradients. FIG. 4 further shows a weight updater 140 which, during the backward pass stage of the training, updates weights of the second processing modules based on the accumulated gradients and produces updated second processing modules.

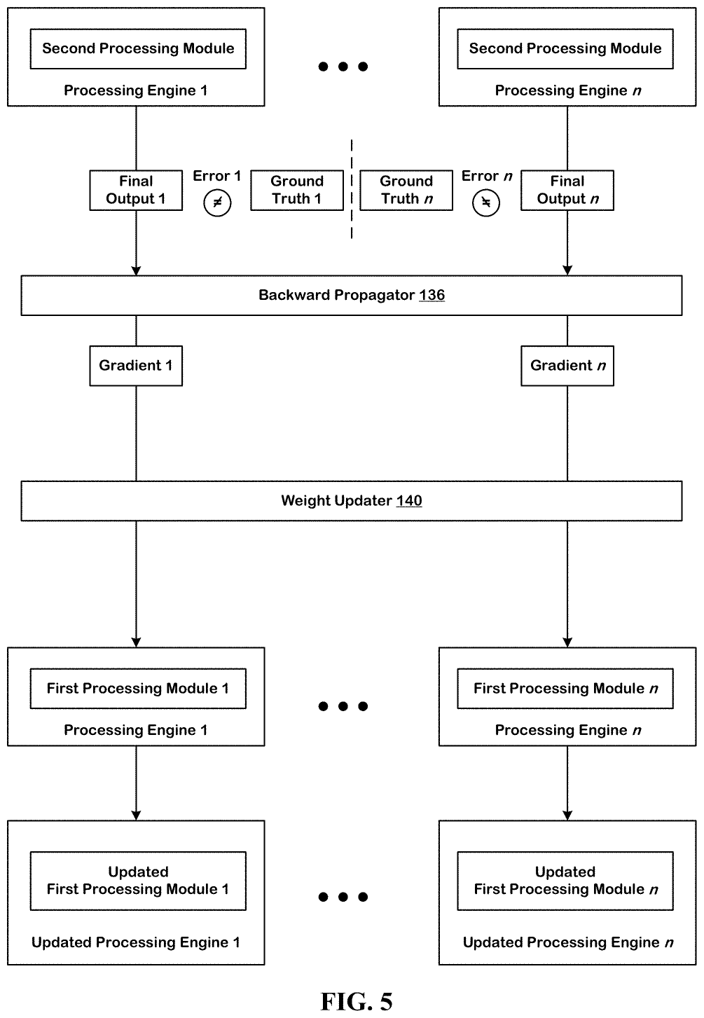

FIG. 5 shows one implementation of the backward propagator 136 which, during the backward pass stage of the training, determines gradients for each first processing modules based on the combined intermediate outputs, the corresponding final outputs, and the corresponding ground truths. FIG. 5 also shows the weight updater 140 which, during the backward pass stage of the training, updates weights of the first processing modules based on the corresponding gradients and produces updated first processing modules.

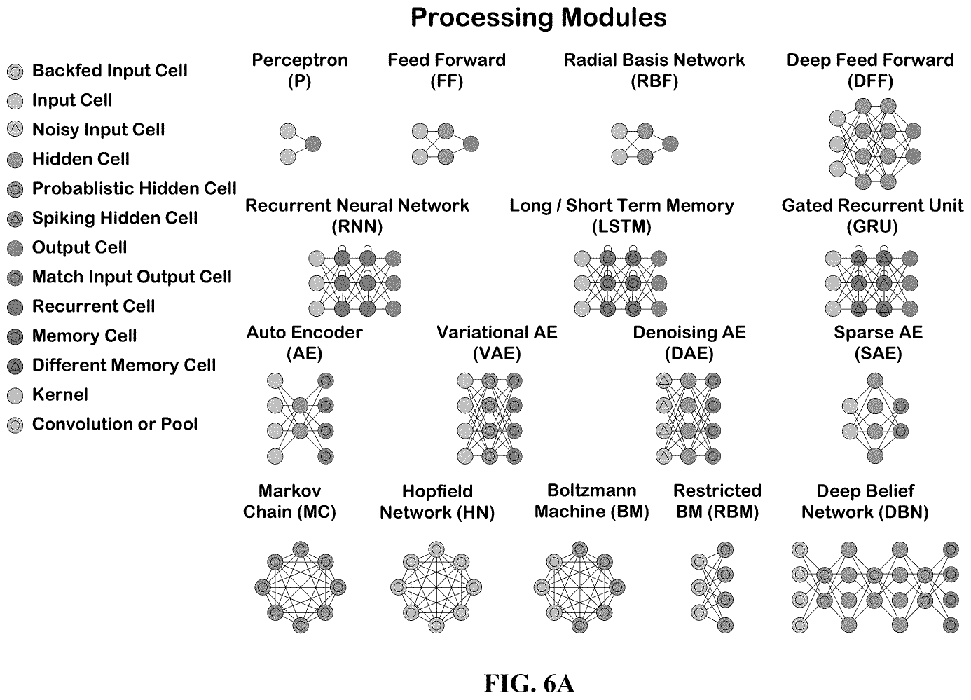

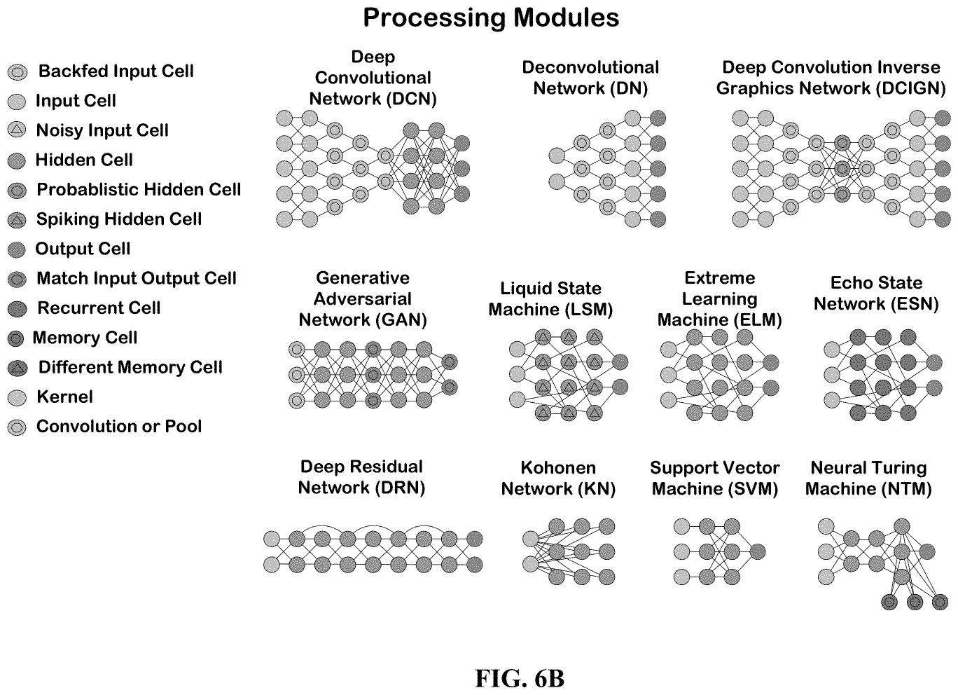

FIGS. 6A and 6B show different examples of the first processing modules (also referred to as encoders) and the second processing modules (also referred to as decoders). We present further details of encoder and decoder in the following sections.

Encoder/First Processing Module

Encoder is a processor that receives information characterizing input data and generates an alternative representation and/or characterization of the input data, such as an encoding. In particular, encoder is a neural network such as a convolutional neural network (CNN), a multilayer perceptron, a feed-forward neural network, a recursive neural network, a recurrent neural network (RNN), a deep neural network, a shallow neural network, a fully-connected neural network, a sparsely-connected neural network, a convolutional neural network that comprises a fully-connected neural network (FCNN), a fully convolutional network without a fully-connected neural network, a deep stacking neural network, a deep belief network, a residual network, echo state network, liquid state machine, highway network, maxout network, long short-term memory (LSTM) network, recursive neural network grammar (RNNG), gated recurrent unit (GRU), pre-trained and frozen neural networks, and so on.

In implementations, encoder includes individual components of a convolutional neural network (CNN), such as a one-dimensional (1D) convolution layer, a two-dimensional (2D) convolution layer, a three-dimensional (3D) convolution layer, a feature extraction layer, a dimensionality reduction layer, a pooling encoder layer, a subsampling layer, a batch normalization layer, a concatenation layer, a classification layer, a regularization layer, and so on.

In implementations, encoder comprises learnable components, parameters, and hyperparameters that can be trained by backpropagating errors using an optimization algorithm. The optimization algorithm can be based on stochastic gradient descent (or other variations of gradient descent like batch gradient descent and mini-batch gradient descent). Some examples of optimization algorithms that can be used to train the encoder are Momentum, Nesterov accelerated gradient, Adagrad, Adadelta, RMSprop, and Adam.

In implementations, encoder includes an activation component that applies a non-linearity function. Some examples of non-linearity functions that can be used by the encoder include a sigmoid function, rectified linear units (ReLUs), hyperbolic tangent function, absolute of hyperbolic tangent function, leaky ReLUs (LReLUs), and parametrized ReLUs (PReLUs).

In some implementations, the encoder/first processing module and decoder/second processing module can include a classification component, though it is not necessary. In preferred implementations, the encoder/first processing module and decoder/second processing module is a convolutional neural network (CNN) without a classification layer such as softmax or sigmoid. Some examples of classifiers that can be used by the encoder/first processing module and decoder/second processing module include a multi-class support vector machine (SVM), a sigmoid classifier, a softmax classifier, and a multinomial logistic regressor. Other examples of classifiers that can be used by the encoder/first processing module include a rule-based classifier.

Some examples of the encoder/first processing module and decoder/second processing module are:
AlexNet
ResNet
Inception (various versions)
WaveNet
PixelCNN
GoogLeNet
ENet
U-Net
BN-NIN
VGG
LeNet
DeepSEA
DeepChem
DeepBind
DeepMotif
FIDDLE
DeepLNC
DeepCpG
DeepCyTOF
SPINDLE

In a processing engine, the encoder/first processing module produces an output, referred to herein as “encoding”, which is fed as input to each of the decoders. When the encoder/first processing module and decoder/second processing module is a convolutional neural network (CNN), the encoding/decoding is convolution data. When the encoder/first processing module and decoder/second processing module is a recurrent neural network (RNN), the encoding/decoding is hidden state data.

Decoder/Second Processing Module

Each decoder/second processing module is a processor that receives, from the encoder/first processing module information characterizing input data (such as the encoding) and generates an alternative representation and/or characterization of the input data, such as classification scores. In particular, each decoder is a neural network such as a convolutional neural network (CNN), a multilayer perceptron, a feed-forward neural network, a recursive neural network, a recurrent neural network (RNN), a deep neural network, a shallow neural network, a fully-connected neural network, a sparsely-connected neural network, a convolutional neural network that comprises a fully-connected neural network (FCNN), a fully convolutional network without a fully-connected neural network, a deep stacking neural network, a deep belief network, a residual network, echo state network, liquid state machine, highway network, maxout network, long short-term memory (LSTM) network, recursive neural network grammar (RNNG), gated recurrent unit (GRU), pre-trained and frozen neural networks, and so on.

In implementations, each decoder/second processing module includes individual components of a convolutional neural network (CNN), such as a one-dimensional (1D) convolution layer, a two-dimensional (2D) convolution layer, a three-dimensional (3D) convolution layer, a feature extraction layer, a dimensionality reduction layer, a pooling encoder layer, a subsampling layer, a batch normalization layer, a concatenation layer, a classification layer, a regularization layer, and so on.

In implementations, each decoder/second processing module comprises learnable components, parameters, and hyperparameters that can be trained by backpropagating errors using an optimization algorithm. The optimization algorithm can be based on stochastic gradient descent (or other variations of gradient descent like batch gradient descent and mini-batch gradient descent). Some examples of optimization algorithms that can be used to train each decoder are Momentum, Nesterov accelerated gradient, Adagrad, Adadelta, RMSprop, and Adam.

In implementations, each decoder/second processing module includes an activation component that applies a non-linearity function. Some examples of non-linearity functions that can be used by each decoder include a sigmoid function, rectified linear units (ReLUs), hyperbolic tangent function, absolute of hyperbolic tangent function, leaky ReLUs (LReLUs), and parametrized ReLUs (PReLUs).

In implementations, each decoder includes a classification component. Some examples of classifiers that can be used by each decoder include a multi-class support vector machine (SVM), a sigmoid classifier, a softmax classifier, and a multinomial logistic regressor. Other examples of classifiers that can be used by each decoder include a rule-based classifier.

The numerous decoders/second processing modules can all be the same type of neural networks with matching architectures, such as fully-connected neural networks (FCNN) with an ultimate sigmoid or softmax classification layer. In other implementations, they can differ based on the type of the neural networks. In yet other implementations, they can all be the same type of neural networks with different architectures.

### Fraud Detection in Health Insurance—Use Case

We now present an example use case in which the technology disclosed can be deployed to solve a problem in the field of health care.

Problem

To demonstrate the capabilities of FCL in the intra-company scenario for a Health Insurer, we present the use case of fraud detection. We imagine a world where health plan members have visits with healthcare providers. This results in some fraud, which we would like to classify. This information lives in two silos: (1) claims submitted by providers, and (2) claims submitted by members, which always correspond 1 to 1. Both or either providers or members may be fraudulent, and accordingly the data to answer the fraud question lies in both or either of the two datasets.

We have broken down our synthetic fraud into six types: three for members (unnecessarily going to providers for visits), and three for providers (unnecessarily performing procedures on members). These types have very specific criteria, which we can use to enrich a synthetic dataset appropriately.

In this example, the technology disclosed can identify potential fraud broken down into six types, grouped in simple analytics, complex analytics, and prediction analytics. The goal is to identify users (or members) and providers in the following two categories.

1. Users who are unnecessarily going to providers for visits

2. Providers that are unnecessarily performing a certain procedure on many users

Simple Analytics:
Report all users who have 3 or more of the same ICD (International Classification of Diseases) codes over the last 6 months
Report all providers (provider_id) who have administered the same ICD code at least 2 times on a given user, on a minimum of 20 users in the last 6 months

Complex Analytics:
Report all users who have a copay of less than $10 but have had visits costing Health Insurer greater than $5,000 in the last 6 months, with each visit being progressively higher than before. If one of the visits was lower than the previous, it is not considered as a fraud.
Report all providers (provider_id) who have administered an ICD code on users with a frequency that is “repeating in a window”. The window here is 2 months, and the minimum windows to see is 4. Only return the providers when the total across all users has exceeded $10,000.

Prediction Analytics:
Report all providers who have administered a user with a frequency that is “repeating in a window”. The window for user's visits is 2 months, during which the user came in at least 4 times and has been prescribed drugs 3 times or greater (e.g. providers overprescribing drugs)
Report all members who came to a provider with a frequency that is “repeating in a window”. The window for user's visits is 2 months, during which the user came in at least 4 times and has been prescribed drugs 2 times or less (e.g. users coming to providers trying to get drugs for opioid addictions)

The six types of fraud are summarized in table 1 below:

| | Simple Analytics | | Complex Analytics | | Prediction Analytics | |
|---|---|---|---|---|---|---|
| Fraud Code | 1 | 2 | 3 | 4 | 5 | 6 |
| User or | User | Provider | User | Provider | Provider | User |
| provider | | | | | | |
| Fraud | Users who | Providers | Users who | Providers | Providers who | Users who came |
| description | have 3 or | who have | have had | who have | have | to a provider |
| | more of | administered | visits | administered | administered a | with a frequency |
| | the same | the same | costing | an ICD | user with a | that is |
| | ICD codes | ICD code at | greater than | code on | frequency that | “repeating in a |
| | over the | least 2 times | $5,000 in | users with a | is “repeating in | window” (e.g. |
| | last 6 | on a given | the last 6 | frequency | a window”. | users coming to |
| | months | user, on a | months, with | that is | (e.g. providers | providers trying |
| | | minimum of | each visit | “repeating | overprescribing | to get drugs for |
| | | 20 users in | being | in a | drugs) | opioid |
| | | the last 6 | progressively | window” | | addictions) |
| | | months | higher | | | |
| | | | than before | | | |

Accordingly, we are assuming that the data required to analyze fraud types 5 and 6 exists on separate clusters:
Claims data does not have prescription information, so from that alone it is not possible to identify whether the provider overprescribed a drug
Provider data does not have user id information (so it is not possible to identify whether the user is going repeatedly to several hospitals)

Dataset

The data is generated by a two-step process, which is decoupled for faster experimentation:

1. Create the raw provider, member, and visit metadata, including fraud.

2. Collect into two partitions (provider claims vs member claims) and featurize.

Many fields are realized categorically, with randomized distributions of correlations between provider/member attributes and the odds of different types of fraud. Some are more structured, such as our fake ICD10 codes and ZIP codes, which are used to connect members to local providers. Fraud is decided on a per-visit basis (6 potential reasons). Tables are related by provider, member, and visit ID. Getting to specifics, we generate the following columns:

Providers Table

Provider ID
Name
Gender
Ethnicity
Role
Experience Level
ZIP Code

Members Table

Member ID
Name
Gender
Ethnicity
Age Level
Occupation
Income Level
ZIP Code
Copay

Visits Table

Visit ID
Provider ID
Member ID
ICD10 Code
Date
Cost
Copay
Cost to Health Insurer
Cost to Member
Num Rx
Fraud P-1
Fraud P-2
Fraud P-3
Fraud M-1
Fraud M-2
Fraud M-3

Execution steps with timings in seconds:
0.011 Create providers
6.550 Map providers
0.047 Create members
0.028 Create visits (member)
0.003 Create visits (date)
0.201 Create visits (member->provider)
0.329 Create visits (provider+member->icd10)
0.223 Create visits (provider+member+icd10->num rx)
1.308 Create visits (provider+member+icd10+num rx->cost)
0.009 Fraud (P1)
0.018 Fraud (P2)
0.040 Fraud (P3)
0.015 Fraud (M1)
0.091 Fraud (M2)
0.039 Fraud (M3)
0.028 Save 20000 providers
0.177 Save 100000 members
3.661 Save 874555 visits

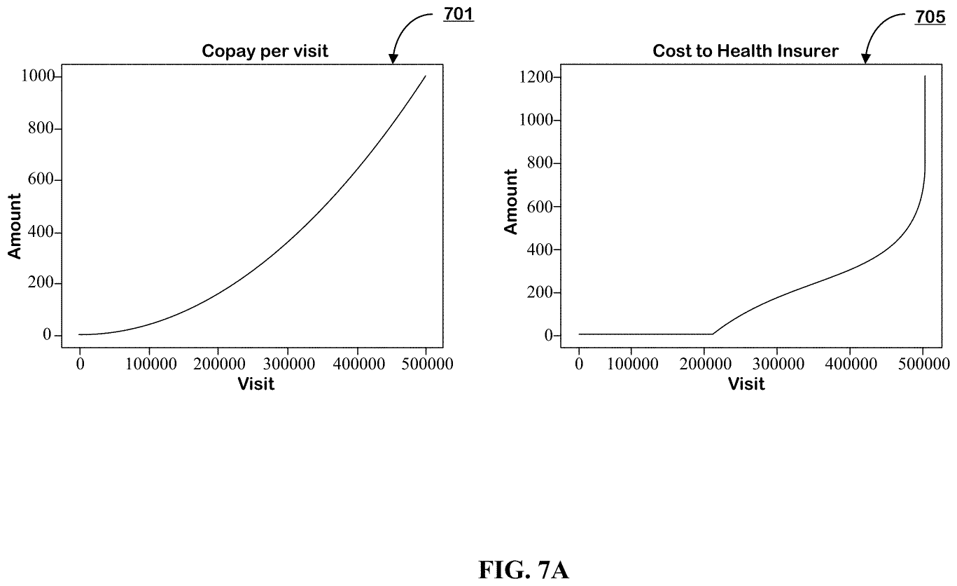

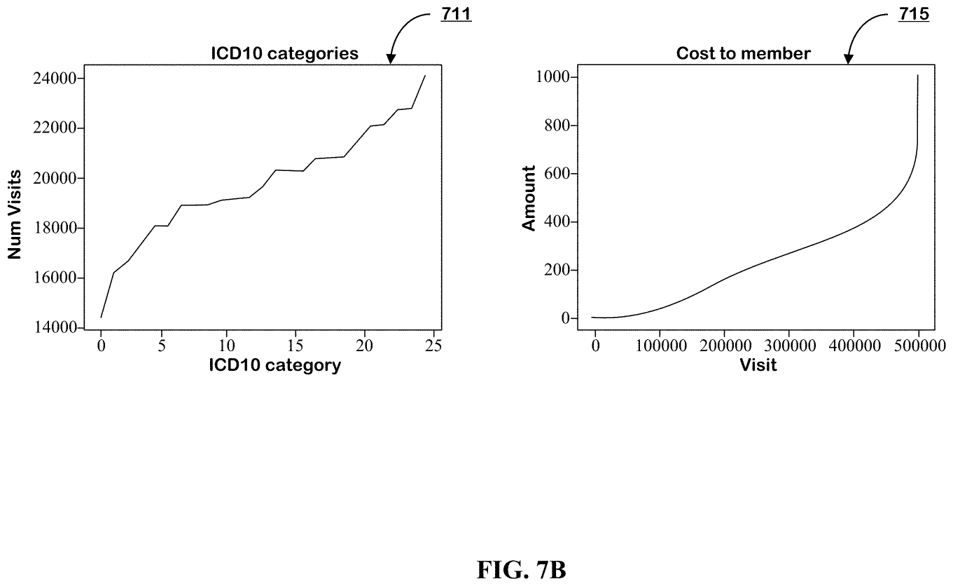

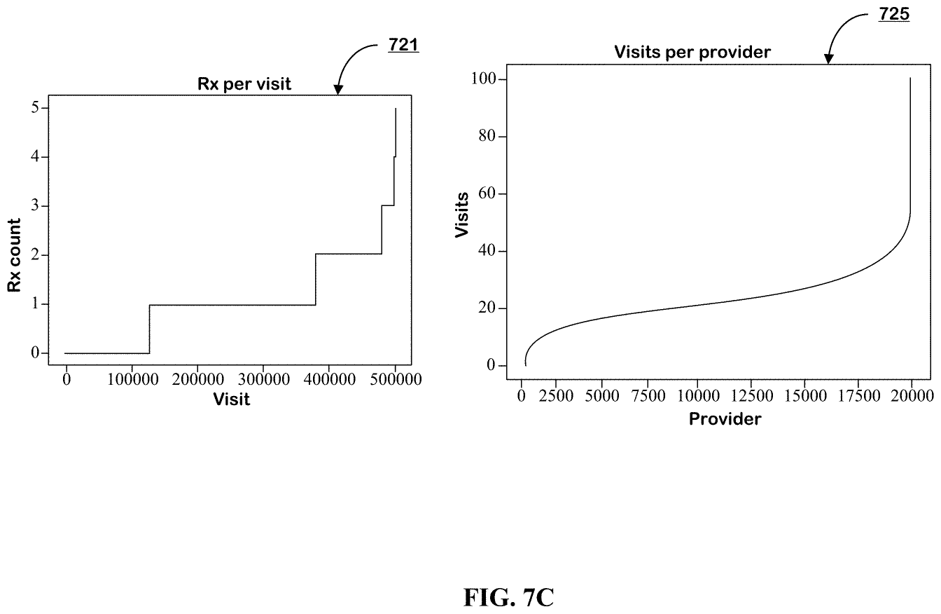

FIGS. 7A to 7C present some distributions of interest across the synthetic non-fraud visits for the above example. These distributions are for a particular dataset and may vary for different datasets. FIG. 7A presents two graphs illustrating the “copay per visit” (labeled 701) for members and “cost to health insurer” (labeled 705) using a data from approximately 500,000 visits. FIG. 7B presents a graph for “ICD10 categories” (labeled 711) illustrating distribution of number of ICD10 categories across the visits. FIG. 7B also presents a graph illustrating distribution of “cost to member” (labeled 715) across the visits. FIG. 7C presents a graph for “prescriptions or Rx per visit” (labeled 721) across the visits and a graph illustrating distribution of “visits per provider” (labeled 725).

Features

The second dataset generation stage, collection and featurization, makes this a good vertically federated learning problem. There is only partial overlap between the features present in the provider claims data and the member claims data. In practice, this makes detecting all types of fraud with high accuracy require both partitions of the feature space.

In practice, much of the gap between the “perfect information” learning curve and 100% accuracy is to be found in inadequate featurization. Providers and members are realized as the group of visits that belong to them. Visit groups are then featurized in the same way. Cost, visit count, date, ICD10, num rx, etc. are all considered relevant. Numbers are often taken as log 2 and one-hot. This results in a feature dimensionality of around 100-200.

Models

For this problem, provider claim and member claim encoder networks are both stock multilayer perceptions (MLPs) with sigmoid outputs (for quantizing in the 0-1 range). The output network is also an MLP, as is almost always true, as this is a classification problem. Trained with categorical cross-entropy loss.

Training

We default to 20% validation, 50 epochs, batch size 1024, encode dim 8, no quantization. We experience approx. half-minute epochs for A, B, and AB—and minute epochs for F—on an unladen NVIDIA RTX 2080. The models were implemented in PyTorch 1.3.1 with CUDA 10.1.

Results

Explanation:

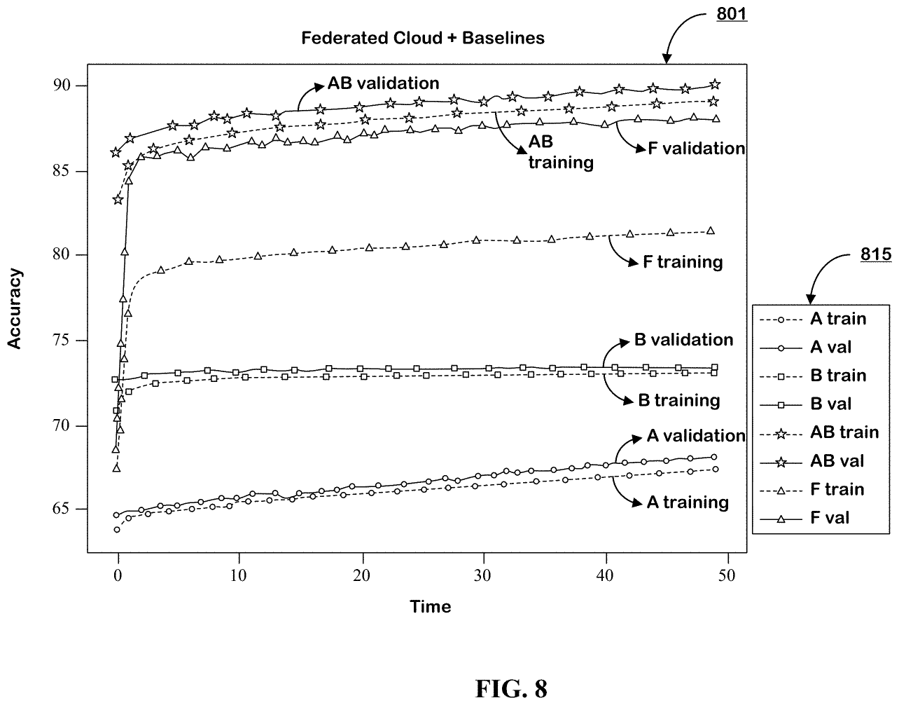

FIG. 8 presents comparative results for the above example. There are two data sources, A and B. Together they can be used to make predictions. Often either A or B are enough to predict, but sometimes you need information from both. Training and validation plots are displayed separately in graph 801 in FIG. 8 for each case listed below. The legend 815 illustrates different shapes of graphical plots for various cases.

The A and B learning curves are their respective datasets taken alone. As these data sources are insufficient when used independently, these form the low-end baselines as shown in FIG. 8. To be successful, FCL must exceed them.

AB is the traditional (non-federated) machine learning task, taking both A and B as input. This is the high-end baseline as shown on the top of end of the graphical plot in FIG. 8. We do not expect to perform better than this curve.

F is the federated cloud learning or FCL curve. Notice how, with uninitialized model memory, it performs as well as either A or B taken alone, then improves as this information forms and stabilizes.

On this challenging dataset, the FCL curve approaches but does not match the AB curve.

Architecture Overview

The overview of the FL architecture is below, ensuring no information is leaked via training.

Network Architecture

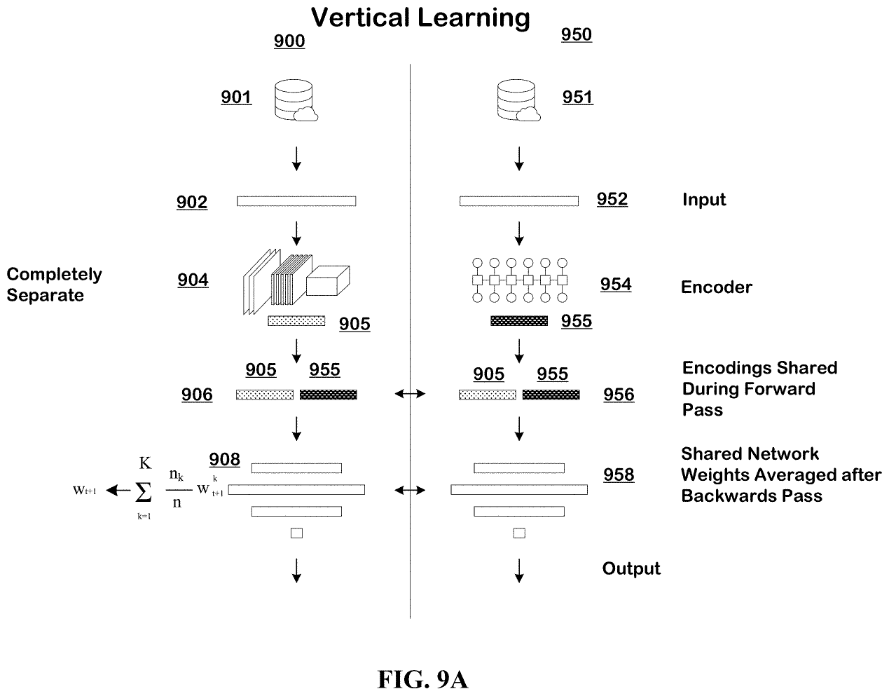

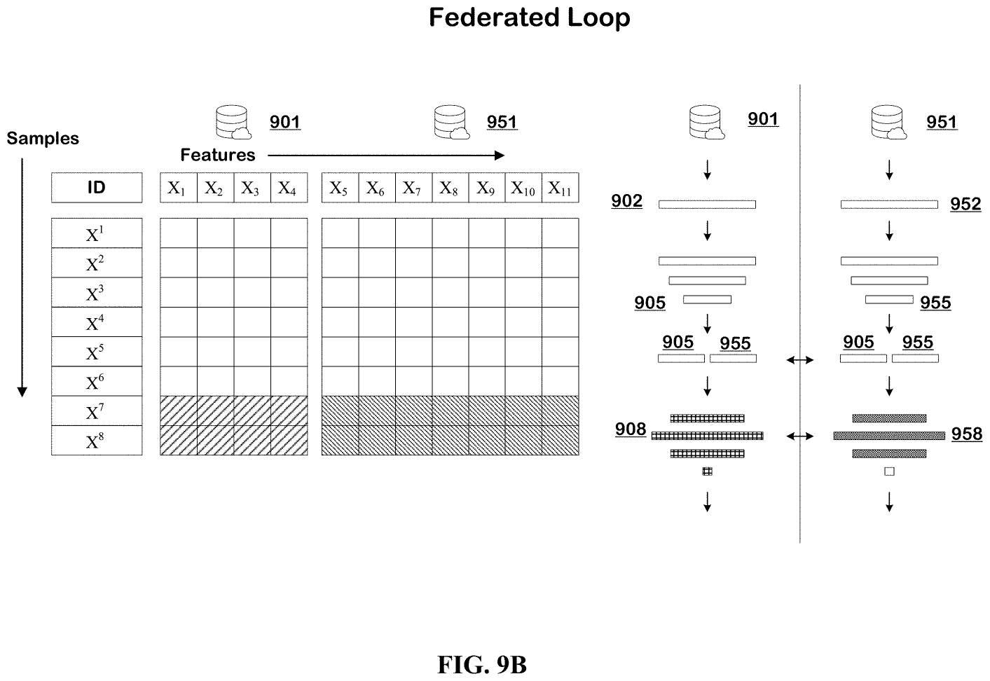

FIG. 9A presents a high-level architecture of federated cloud learning (FCL) system. The example shows two systems 900 and 950 with respective data silos labeled as 901 and 951, respectively. The data silos (901 and 951) can be owned by two groups or departments within an organization (or an institution) or these can be owned by two separate organizations. We can also refer to these two data silos as subsets of the data. Each system that controls access to a subset of the data can run its own network. The two systems have separate input features 902 and 952 which are generated from data subsets (or data silos) 901 and 951 respectively.

The networks, for each system, are split into two parts: an encoder that is built specifically for the feature subset that it addresses, and a “shared” deeper network that takes the encodings as inputs to produce an output. The encoder networks are fully isolated from one another and do not need to share their architecture. For example, the encoder on the left (labeled 904) could be a convolutional network that works with image data while the encoder on the right (labeled 954) could be a recurrent network that addresses natural language inputs. The encoding from encoder 904 is labeled as 905 and encoding from encoder 954 is labeled as 955.

The “shared” portion of each network, on the other hand, has the same architecture, and the weights will be averaged across the networks during training so that they converge to the same values. Data is fed into each network row-wise, that is to say, by sample, but with each network only having access to its subset of the feature space. The rows of data from separate data sets but belonging to same sample are shown in a table in FIG. 9B, which is explained in the following section. The networks can run in parallel to produce their respective encodings (labeled 905 and 955, respectively), at which point the encodings are shared via some coordinating system. Each network then concatenates the encodings sample-wise (labeled 906 and 956, respectively) and feeds the concatenation into the deeper part of the network. At this point, although the networks are running separately, they are running the same concatenated encodings through the same architecture. Because the networks may be initialized with different random weights, the outputs may be different, so after the backwards pass the weights are averaged together (labeled 908 and 958, respectively), which can result in their convergence over a number of iterations. This process is repeated until training is stopped.

Architecture Properties

One of the important features of this federated architecture is that the separate systems do not need to know anything about each other's dataset. FIG. 9B uses the same reference numbers for elements of two systems as shown in FIG. 9A and includes a table to show features (as columns) and samples (as rows) from the two data subsets, respectively. In an ideal scenario as shown in FIG. 9B, there is no overlap in the feature space. For example, the data subset 901 includes features X₁, X₂, X₃, and X₄ shown as columns in a left portion of the table in FIG. 9B. The data subset 951 includes features X₅, X₆, X₇, X₈ X₉, X₁₀, and X₁₁ shown as columns in a right portion of the table in FIG. 9B. Therefore, it is unnecessary to share the data schemas, distributions, or any other information about the raw data. All that is shared is the encoding produced by the encoder subnetwork, which effectively accomplishes a reduction in the data's dimensionality without sharing anything about its process. The encodings from the encoders in the two networks are labeled as 905 and 955 in FIG. 9B. Examples of samples (labeled X¹ through X⁸) are arranged row-wise in the table shown in FIG. 9B.

Each network runs separately from other networks therefore each network has access to the target output. The labels and the values (from the target output) that the federated system will be trained to predict are shared across networks. In less ideal cases where there is overlap in the feature subsets it may be necessary to coordinate on decisions about how the overlap will be addressed. For example, one of the subsets could simply be designated as the canonical representation of the shared feature, so that it is ignored in the other subset, or the values could be averaged or otherwise combined prior to processing by the encoders.

Federated cloud learning (FCL) is about a basic architecture and training mechanism. The actual neural networks used are custom to the problem at hand. The unifying elements, in order of execution, are:
1. Each party has and runs its own private neural network to transform its sample parts into encodings. Conceivably these encodings are a high-density blurb of the information in the samples that will be relevant to the work of the output network.
2. A memory layer that stores these encodings and is synchronized across parties between epochs. Requires samples×parties×encode dim×bits per float bits. To take the example of our synthetic healthcare fraud test dataset: 1 m×2×8×8=128 mb of overhead.
3. An output neural network, which operates on the encodings retrieved out of the memory, with the exception of the party's own encoder's outputs, which are used directly. This means that the backpropagation signal travels back through the private encoder of each party, thereby touching all the weights and allowing the networks to be trained jointly, making learning possible.

### Additional Experiments

We have applied federated cloud learning (FCL) and vertical federated learning (VFL) to the following problems that have very different characteristics and have found common themes and generalized our learnings:

1. Parity

Using the technology disclosed, we predict the parity of a collection of bits that have partitioned into multiple shards using the FCL architecture. We detected a yawning gap between one-shard knowledge (50% accuracy) and total knowledge (100% accuracy). FCL is a little slower to converge, especially at higher quantizations, more sample bits, and tighter encoding dimensionalities, but it does converge. It displays some oscillatory behavior due to the long memory update/short batch update tick/tock, combined with the efficiency with which the encodings need to preserve sample bits causing model sensitivity.

2. CLEVR

CLEVR is an image dataset for synthetic visual question and answer challenge and yields itself to (a) a questions dataset and (b) an associated images dataset, which together we can use with the FCL architecture. Also notable for the different encoder architectures, we can use (CONV2D+CONV1D/RNN/Transformer), which the optimizer favors in different ways.

3. Higgs Boson

Higgs boson detection dataset can be cleaved into what it describes as low-level features and a set of derived high-level features, which can be fed to respective multilayer perceptrons (MLPs). It showcases the overlap and correlations so often present in real-world data, also known as the power of deep learning.

4. Other Data Sources and Use Cases

The technology disclosed can be applied to other data sources listed below.

TABLE 2
Example Data Sources

| Data Source/Data Silo | Example Information/Input Features |
|---|---|
| Health Insurer | Claims |
| | Medications/Drugs |
| | Labs |
| | Plans |
| Pharmaceutical | Drugs |
| | Biopsies |
| | Trials and results |
| Wearables | Bedside monitors |
| | Trackers |
| Genomics | Genetics data |
| Mental health | Data from Mental Health Applications |
| | (such as Serenity) |
| Banking | FICO |
| | Spending |
| | Income |
| Mobility | Mobility |
| | Return to work tracking |
| Clinical trials | Clinical trials data |
| IoT | Data from Internet of Things (IoT) devices, |
| | such as from Bluetooth Low Energy-powered |
| | networks that help organizations and cities |
| | connect and collect data from their devices, |
| | sensors, and tags. |

We present below in table 3 some example use cases of the technology disclosed using the data listed in table 2 above.

TABLE 3
Example Use Cases

| Problem Type | Use Case/Description of Problem | Required Data |
|---|---|---|
| Medical Adherence | Predicting a person's likelihood of | All the data sources listed |
| | following a medical protocol (i.e., | above in table 2. |
| | medication adherence, deferred care, | |
| | etc.) | |
| Survival | Predicting a person's survival in the | Claims |
| Score/Morbidity (for | next time period given preconditions | Medications |
| any precondition) | from several modes. | Genomic |
| | | Activity Monitor |
| Predicting Total Cost of | Predicting frequency and severity of | Claims |
| Care (tCoC) for future | symptoms which is linked to tCoC. | Medications |
| Period | This is a complex issue linked with a | Genomic |
| | person's genome, activity and eating | Activity |
| | habits. | Food Consumed |
| Predicting Personal | Predict whether someone will | Activity records |
| Productivity (Burnout | experience productivity issues. | food eating habits |
| Likelihood) | | Phone usage time |
| Predicting Manic and | Predict whether someone is or will | Claims records |
| Depressive States for | experience a mental health episode. | Medication records |
| People with Manic | Specific examples include prediction | activity records |
| Depression | mania or depression for people with | Spending habits |
| | manic depression due to specific | |
| | environmental triggers | |
| Default on Loan | Predict whether or not some is likely | Mental Health |
| | to default on a loan. Typically uses | BCBS |
| | FICO score but could potentially be | FICO score/banking |
| | more accurate with more sectors of | info |
| | data | Wearables |
| Synthetic control arms | Build a control arm that is based on | EMR/EHR data |
| | the real-world data from the sources | Medications |
| | described above on the same | Mobility |
| | population of users. The synthetic | Labs data |
| | arms can act as the control arms for | Food Consumed |
| | phase3 studies where either a new | |
| | drug or a revision of the drug is | |
| | being tested. The synthetic arm | |
| | could be instead of a placebo arm | |
| | with a prior drug as well. | |

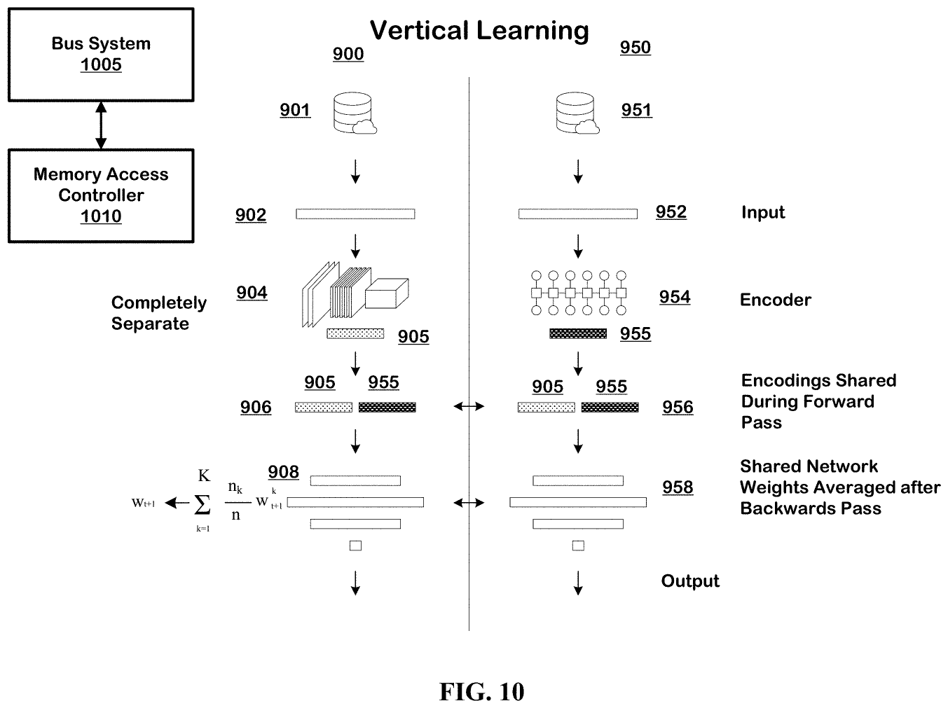

FIG. 10 presents a system for aggregating feature spaces from disparate data silos to execute joint training and prediction tasks. Elements of system in FIG. 10 that are similar to elements of FIGS. 9A and 9B are referenced using same labels. The system comprises a plurality of prediction engines. A prediction engine can include at least one encoder 904 and at least one decoder 908. Training data can comprise of a plurality of data subsets or data silos such as 901, and 951. Input features from data silos are fed to respective prediction engines.

In FIG. 10, two data silos 901 and 951 are shown for illustrations purposes. A data silo can store data related to a user. A data silo can contain raw data from a data source such as a health insurer, pharmaceutical company, a wearable device provider, a genomics data provider, a mental health application, a banking application, a mobility data provider, clinical trials, etc. For example, one data silo can contain prescription drugs information for a particular user and another data silo can contain data collected from bedside monitors or wearable device for the same particular user. For privacy and regulatory reasons, data from one data silo may not be shared with external systems. Examples of data silos are presented in Table 2 above. Input features can be extracted from data silos and provided as inputs to respective encoders in respective processing pipelines. Systems 900 and 950 can be considered as separate processing pipelines, each containing a data silo and respective prediction engine. Each data silo has respective feature space that has input features for an overlapping population that spans respective feature spaces. For example, data silo 901 has input features 902 and data silo 951 has input features 952, respectively.

A bus system 1005 is connected to the plurality of prediction engines. The bus system is configurable to partition the respective prediction engines into respective processing pipelines. The bus system 1005 can block input feature exchange via the bus system between an encoder within a particular processing pipeline and encoders outside the particular processing pipeline. For example, the bus system 1005 can block exchange of input features 902 and 952 with encoders outside their respective processing pipelines. Therefore, the encoder 904 does not have access to input features 952 and the encoder 954 does not have access to input features 902.

The system presented in FIG. 10 includes a memory access controller 1010 connected to the bus system 1005. The memory access controller is configurable to confine access of the encoder within the particular processing pipeline to input features of a feature space of a data silo allocated to the particular processing pipeline. The memory access controller is also configurable to allow access of a decoder within the particular processing pipeline to encoding generated by the encoder within the particular processing pipeline. Further, the memory access controller is configurable to allow access of a decoder to encodings generated by the encoders outside the particular processing pipeline. For example, the encoder 908 in processing pipeline has access to encoding 905 from its own particular processing pipeline 900 and also to encoding 955 which is outside the particular pipeline 900.

The system includes a joint prediction generator connected to the plurality of prediction engines. The joint prediction generator is configurable to process input features from the respective feature spaces of the respective data silos through encoders of corresponding allocated processing pipelines to generate corresponding encodings. The joint prediction generator can combine the corresponding encodings across the processing pipelines to generate combined encodings. The joint prediction generator can process the combined encodings through the decoders to generate a unified prediction for members of the overlapping population. Examples of such predictions are presented in Table 3 above. For example, the system can predict a person's likelihood of following a medical protocol, or predict whether a person can experience burnout or productivity issues.

The technology disclosed provides a platform to jointly train a plurality of prediction engines as described above and illustrated in FIG. 10. Thus, one system or processing pipeline does not need to have access to raw data stored in data silos or input features from other systems or processing pipelines. The training of prediction generator is performed using encodings shared by other systems via the memory access controller as described above. The technology disclosed, thus provides a joint training generator for training a plurality of prediction engines that have access to their respective data silos and are blocked from accessing data silos or input features of other prediction engines.

The trained system can be used to execute joint prediction tasks. The system comprises a joint prediction generator connected to a plurality of prediction engines. The joint prediction generator is configurable to process input features from respective feature spaces of respective data silos through encoders of corresponding allocated prediction engines in the plurality of prediction engines to generate corresponding encodings. The prediction generator can combine the corresponding encodings across the prediction engines to generate combined encodings. The prediction generator can process the combined encodings through respective decoders of the prediction engines to generate a unified prediction for members of an overlapping population that spans the respective feature space.

### Particular Implementations

We describe implementations of a system for training processing engines.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A computer-implemented method implementation of the technology disclosed includes accessing a plurality of processing engines. Each processing engine in the plurality of processing engines can have at least a first processing module and a second processing module. The first processing module in each processing engine is different from a corresponding first processing module in every other processing engine. The second processing module in each processing engine is same as a corresponding second processing module in every other processing engine.

The computer-implemented method includes deploying each processing engine to a respective hardware module in a plurality of hardware modules for training.

During forward pass stage of the training, the computer-implemented method includes processing inputs through the first processing modules of the processing engines and producing an intermediate output for each first processing module.

During the forward pass stage of the training, the computer-implemented method includes combining intermediate outputs across the first processing modules and producing a combined intermediate output for each first processing module.

During the forward pass stage of the training, the computer-implemented method includes processing combined intermediate outputs through the second processing modules of the processing engines and producing a final output for each second processing module.

During the backward pass stage of the training, the computer-implemented method includes determining gradients for each second processing module based on corresponding final outputs and corresponding ground truths.

During the backward pass stage of the training, the computer-implemented method includes accumulating the gradients across the second processing modules and producing accumulated gradients.

During the backward pass stage of the training, the computer-implemented method includes updating weights of the second processing modules based on the accumulated gradients and producing updated second processing modules.

This method implementation and other methods disclosed optionally include one or more of the following features. This method can also include features described in connection with systems disclosed. In the interest of conciseness, alternative combinations of method features are not individually enumerated. Features applicable to methods, systems, and articles of manufacture are not repeated for each statutory class set of base features. The reader will understand how features identified in this section can readily be combined with base features in other statutory classes.

One implementation of the computer-implemented method includes determining gradients for each first processing module during the backward pass stage of the training based on the combined intermediate outputs, the corresponding final outputs, and the corresponding ground truths. The method includes, during the backward pass stage of the training, updating weights of the first processing modules based on the determined gradients and producing updated first processing modules.

In one implementation, the computer-implemented method includes storing the updated first processing modules and the updated second processing modules as updated processing engines. The method includes making the updated processing engines available for inference.

The hardware module can be a computing device and/or edge device. The hardware module can be a chip or a part of a chip.

In one implementation, the computer-implemented method includes accumulating the gradients across the second processing modules and producing the accumulated gradients by determining weighted averages of the gradients.

In one implementation, the computer-implemented method includes accumulating the gradients across the second processing modules and producing the accumulated gradients by determining averages of the gradients.

In one implementation, the computer-implemented method includes combining the intermediate outputs across the first processing modules and producing the combined intermediate output for each first processing module by concatenating the intermediate outputs across the first processing modules.

In another implementation, the computer-implemented method includes combining the intermediate outputs across the first processing modules and producing the combined intermediate output for each first processing module by summing the intermediate outputs across the first processing modules.

In one implementation, the inputs processed through the first processing modules of the processing engines can be a subset of features selected from a plurality of training examples in a training set. In such implementation, the inputs processed through the first processing modules of the processing engines can be a subset of the plurality of the training examples in the training set.

In one implementation, the computer-implemented method includes selecting and encoding inputs for a particular first processing module based at least on an architecture of the particular first processing module and/or a task performed by the particular first processing module.

In one implementation, the computer-implemented method includes using parallel processing for performing the training of the plurality of processing engines.

In one implementation, the computer-implemented method includes the first processing modules that have different architectures and/or different weights.

In one implementation, the computer-implemented method includes the second processing modules that are copies of each other such that they have a same architecture and/or same weights.

The first processing modules can be neural networks, deep neural networks, decision trees, or support vector machines.

The second processing modules can be neural networks, deep neural networks, classification layers, or regression layers.

In one implementation, the first processing modules are encoders, and the intermediate outputs are encodings.

In one implementation, the second processing modules are decoders and the final outputs are decodings.

In one implementation, the computer-implemented method includes iterating the training until a convergence condition is reached. In such implementation, the convergence condition can be a threshold number of training iterations.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Computer readable media (CRM) implementations of the technology disclosed include a non-transitory computer readable storage medium impressed with computer program instructions, when executed on a processor, implement the method described above.

Each of the features discussed in this particular implementation section for the method implementation apply equally to the CRM implementation. As indicated above, all the system features are not repeated here and should be considered repeated by reference.

A system implementation of the technology disclosed includes one or more processors coupled to memory. The memory is loaded with computer instructions to train processing engines. The system comprises a memory that can store a plurality of processing engines. Each processing engine in the plurality of processing engines can have at least a first processing module and a second processing module. The first processing module in each processing engine is different from a corresponding first processing module in every other processing engine. The second processing module in each processing engine is same as a corresponding second processing module in every other processing engine.

The system comprises a deployer that deploys each processing engine to a respective hardware module in a plurality of hardware modules for training.

The system comprises a forward propagator which can process inputs during forward pass stage of the training. The forward propagator can process inputs through the first processing modules of the processing engines and produce an intermediate output for each first processing module.

The system comprises a combiner which can combine intermediate outputs during the forward pass stage of the training. The combiner can combine intermediate outputs across the first processing modules and produce a combined intermediate output for each first processing module.

The forward propagator, during the forward pass stage of the training, can process combined intermediate outputs through the second processing modules of the processing engines and produces a final output for each second processing module.

The system comprises a backward propagator which, during backward pass stage of the training, can determine gradients for each second processing module based on corresponding final outputs and corresponding ground truths.

The system comprises a gradient accumulator which, during the backward pass stage of the training, can accumulate the gradients across the second processing modules and can produce accumulated gradients.

The system comprises a weight updater which, during the backward pass stage of the training, can update weights of the second processing modules based on the accumulated gradients and can produce updated second processing modules.

This system implementation optionally includes one or more of the features described in connection with method disclosed above. In the interest of conciseness, alternative combinations of method features are not individually enumerated. Features applicable to methods, systems, and articles of manufacture are not repeated for each statutory class set of base features. The reader will understand how features identified in this section can readily be combined with base features in other statutory classes.

Other implementations may include a non-transitory computer readable storage medium storing instructions executable by a processor to perform functions of the system described above. Yet another implementation may include a method performing the functions of the system described above.

A computer readable storage medium (CRM) implementation of the technology disclosed includes a non-transitory computer readable storage medium impressed with computer program instructions to train processing engines. The instructions when executed on a processor, implement the method described above.

Each of the features discussed in this particular implementation section for the method implementation apply equally to the CRM implementation. As indicated above, all the method features are not repeated here and should be considered repeated by reference.

Other implementations may include a method of aggregating feature spaces from disparate data silos to execute joint training and prediction tasks using the systems described above. Yet another implementation may include non-transitory computer readable storage medium storing instructions executable by a processor to perform the method described above.

Computer readable media (CRM) implementations of the technology disclosed include a non-transitory computer readable storage medium impressed with computer program instructions, when executed on a processor, implement the method described above.

Each of the features discussed in this particular implementation section for the system implementation apply equally to the method and CRM implementation. As indicated above, all the system features are not repeated here and should be considered repeated by reference.

Particular Implementations—Aggregating Feature Spaces from Data Silos

We describe implementations of a system for aggregating feature spaces from disparate data silos to execute joint training and prediction tasks.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A first system implementation of the technology disclosed includes one or more processors coupled to memory. The memory is loaded with computer instructions to aggregate feature spaces from disparate data silos to execute joint prediction tasks. The system comprises a plurality of prediction engines, respective prediction engines in the plurality of prediction engines having respective encoders and respective decoders. The system comprises a plurality of data silos, respective data silos in the plurality of data silos having respective feature spaces that have input features for an overlapping population that spans the respective feature spaces. The system comprises a bus system connected to the plurality of prediction engines. The bus system is configurable to partition the respective prediction engines into respective processing pipelines. The bus system is configurable to block input feature exchange via the bus system between an encoder within a particular processing pipeline and encoders outside the particular processing pipeline.

The system comprises a memory access controller connected to the bus system. The memory access controller is configurable to confine access of the encoder within the particular processing pipeline to input features of a feature space of a data silo allocated to the particular processing pipeline. The memory access controller is configurable to allow access of a decoder within the particular processing pipeline to encoding generated by the encoder within the particular processing pipeline. The memory access controller is configurable to allow access of a decoder to encodings generated by the encoders outside the particular processing pipeline.

The system comprises a joint prediction generator connected to the plurality of prediction engines. The joint prediction generator is configurable to process input features from the respective feature spaces of the respective data silos through encoders of corresponding allocated processing pipelines to generate corresponding encodings. The joint prediction generator is configurable to combine the corresponding encodings across the processing pipelines to generate combined encodings. The joint prediction generator is configurable to process the combined encodings through the decoders to generate a unified prediction for members of the overlapping population.

This system implementation and other systems disclosed optionally include one or more of the following features. This system can also include features described in connection with methods disclosed. In the interest of conciseness, alternative combinations of system features are not individually enumerated. Features applicable to methods, systems, and articles of manufacture are not repeated for each statutory class set of base features. The reader will understand how features identified in this section can readily be combined with base features in other statutory classes.

The prediction engines can comprise convolutional neural networks (CNNs), long short-term memory (LSTM) neural networks, attention-based models like Transformer deep learning models and Bidirectional Encoder Representations from Transformers (BERT) machine learning models, etc.

One of more data silos in the plurality of data silos can store medical images, claims data from a health insurer, mental health data from a mental health application, data from wearable devices, trackers or bedside monitors, genomics data, banking data, mobility data, clinical trials data, etc.

One or more feature spaces in the respective feature spaces of the plurality of data silos include prescription drugs information, insurance plans information, activity information from wearable devices, etc.

The unified prediction can include survival score predicting a person's survival in the next time period. The unified prediction can include burnout prediction indicating a person's likelihood of experiencing productivity issues. The unified prediction can include predicting whether a person will experience a mental health episode or manic depression. The unified prediction can include likelihood that a person will default on a loan. The unified prediction can include predicting efficacy of a new drug or a new medical protocol.

A second system implementation of the technology disclosed includes one or more processors coupled to memory. The memory is loaded with computer instructions to aggregate feature spaces from disparate data silos to execute joint prediction tasks. The system comprises a joint prediction generator connected to a plurality of prediction engines. The plurality of prediction engines have respective encoders and respective decoders that are configurable to process input features from respective feature spaces of respective data silos through the respective encoders to generate respective encodings, to combine the respective encodings to generate combined encodings, and to process the combined encodings through the respective decoders to generate a unified prediction for members of an overlapping population that spans the respective feature spaces.

This system implementation and other systems disclosed optionally include one or more of the features listed above for the first system implementation. In the interest of conciseness, the individual features of the first system implementation are not enumerated for the second system implementation.

A third system implementation of the technology disclosed includes one or more processors coupled to memory. The memory is loaded with computer instructions to aggregate feature spaces from disparate data silos to execute joint training tasks. The system comprises a plurality of prediction engines, respective prediction engines in the plurality of prediction engines can have respective encoders and respective decoders configurable to generate gradients during training. The system comprises a plurality of data silos, respective data silos in the plurality of data silos can have respective feature spaces that have input features for an overlapping population that spans the respective feature spaces. The input features are configurable as training samples for use in the training. The system comprises a bus system connected to the plurality of prediction engines and configurable to partition the respective prediction engines into respective processing pipelines. The bus system is configurable to block training sample exchange and gradient exchange via the bus system during the training between an encoder within a particular processing pipeline and encoders outside the particular processing pipeline.

The system comprises a memory access controller connected to the bus system and configurable to confine access of the encoder within the particular processing pipeline to input features of a feature space of a data silo allocated as training samples to the particular processing pipeline and to gradients generated from the training of the encoder within the particular processing pipeline. The memory access controller is configurable to allow access of a decoder within the particular processing pipeline to gradients generated from the training of the decoder within the particular processing pipeline and to gradients generated from the training of decoders outside the particular processing pipeline.

The system comprises a joint trainer connected to the plurality of prediction engines and configurable to process, during the training, input features from the respective feature spaces of the respective data silos through the respective encoders of corresponding allocated processing pipelines to generate corresponding encodings. The joint trainer is configurable to combine the corresponding encodings across the processing pipelines to generate combined encodings. The joint trainer is configurable to process the combined encodings through the respective decoders to generate respective predictions for members of the overlapping population. The joint trainer is configurable to generate a combined gradient set from respective gradients of the respective decoders generated based on the respective predictions. The joint trainer is configurable to generate respective gradients of the respective encoders based on the combined encodings. The joint trainer is configurable to update the respective decoders based on the combined gradient set, and to update the respective encoders based on the respective gradients.

This system implementation and other systems disclosed optionally include one or more of the features listed above for the first system implementation. In the interest of conciseness, the individual features of the first system implementation are not enumerated for the third system implementation.

A fourth system implementation of the technology disclosed includes a system comprising a joint trainer connected to a plurality of prediction engines have respective encoders and respective decoders that are configurable to process, during training, input features from respective feature spaces of respective data silos through the respective encoders to generate respective encodings. The joint trainer is configurable to combine the respective encodings across encoders to generate combined encodings. The joint trainer is configurable to process the combined encodings through the respective decoders to generate respective predictions for members of an overlapping population. The joint trainer is configurable to generate a combined gradient set from respective gradients of the respective decoders generated based on the respective predictions. The joint trainer is configurable to generate respective gradients of the respective encoders based on the combined encodings. The joint trainer is configurable to update the respective decoders based on the combined gradient set, and to update the respective encoders based on the respective gradients.

This system implementation and other systems disclosed optionally include one or more of the features listed above for the first system implementation. In the interest of conciseness, the individual features of the first system implementation are not enumerated for the fourth system implementation.

Other implementations may include a method of aggregating feature spaces from disparate data silos to execute joint training and prediction tasks using the systems described above. Yet another implementation may include non-transitory computer readable storage

Method implementations of the technology disclosed include aggregating feature spaces from disparate data silos to execute joint training and prediction tasks by using the system implementations described above.

Each of the features discussed in this particular implementation section for the system implementation apply equally to the method implementation. As indicated above, all the method features are not repeated here and should be considered repeated by reference.

Computer readable media (CRM) implementations of the technology disclosed include a non-transitory computer readable storage medium impressed with computer program instructions, when executed on a processor, implement the method described above.

Each of the features discussed in this particular implementation section for the system implementation apply equally to the method and CRM implementation. As indicated above, all the system features are not repeated here and should be considered repeated by reference.

Computer System

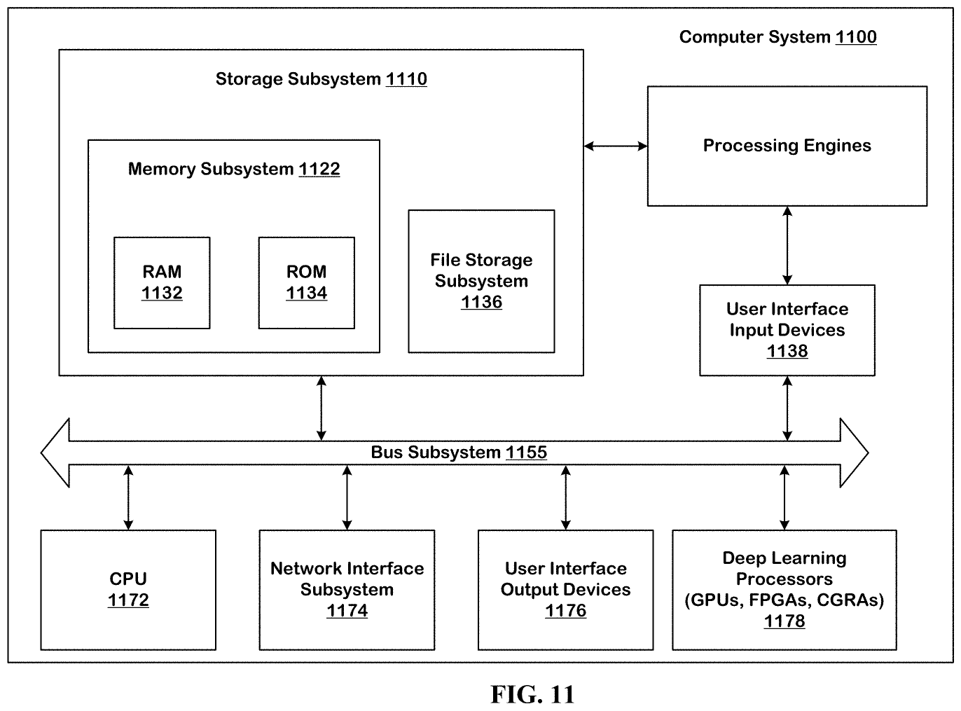

FIG. 11 is a simplified block diagram of a computer system 1100 that can be used to implement the technology disclosed. Computer system 1100 includes at least one central processing unit (CPU) 1172 that communicates with a number of peripheral devices via bus subsystem 1155. These peripheral devices can include a storage subsystem 1110 including, for example, memory devices and a file storage subsystem 1136, user interface input devices 1138, user interface output devices 1176, and a network interface subsystem 1174. The input and output devices allow user interaction with computer system 1100. Network interface subsystem 1174 provides an interface to outside networks, including an interface to corresponding interface devices in other computer systems.

In one implementation, the processing engines are communicably linked to the storage subsystem 1110 and the user interface input devices 1138.

User interface input devices 1138 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1100.

User interface output devices 1176 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1100 to the user or to another machine or computer system.

Storage subsystem 1110 stores programming and data constructs that provide the functionality of some or all of the modules and methods described herein. Subsystem 1178 can be graphics processing units (GPUs) or field-programmable gate arrays (FPGAs).

Memory subsystem 1122 used in the storage subsystem 1110 can include a number of memories including a main random access memory (RAM) 1132 for storage of instructions and data during program execution and a read only memory (ROM) 1134 in which fixed instructions are stored. A file storage subsystem 1136 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1136 in the storage subsystem 1110, or in other machines accessible by the processor.

Bus subsystem 1155 provides a mechanism for letting the various components and subsystems of computer system 1100 communicate with each other as intended. Although bus subsystem 1155 is shown schematically as a single bus, alternative implementations of the bus subsystem can use multiple busses.

Computer system 1100 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1100 depicted in FIG. 11 is intended only as a specific example for purposes of illustrating the preferred embodiments of the present invention. Many other configurations of computer system 1100 are possible having more or less components than the computer system depicted in FIG. 11.

The computer system 1100 includes GPUs or FPGAs 1178. It can also include machine learning processors hosted by machine learning cloud platforms such as Google Cloud Platform, Xilinx, and Cirrascale. Examples of deep learning processors include Google's Tensor Processing Unit (TPU), rackmount solutions like GX4 Rackmount Series, GX8 Rackmount Series, NVIDIA DGX-1, Microsoft' Stratix V FPGA, Graphcore's Intelligent Processor Unit (IPU), Qualcomm's Zeroth platform with Snapdragon processors, NVIDIA's Volta, NVIDIA's DRIVE PX, NVIDIA's JETSON TX1/TX2 MODULE, Intel's Nirvana, Movidius VPU, Fujitsu DPI, ARM's DynamiclQ, IBM TrueNorth, and others.

We claim as follows:

1. A computer-implemented method of training processing engines, the method including:
accessing a plurality of processing engines,
wherein each processing engine in the plurality of processing engines has at least a first processing module and a second processing module,
wherein the first processing module in each processing engine is different from a corresponding first processing module in every other processing engine, and
wherein the second processing module in each processing engine is same as a corresponding second processing module in every other processing engine;
deploying each processing engine to a respective hardware module in a plurality of hardware modules for training;
processing, during forward pass stage of the training, inputs through the first processing modules of the processing engines and producing an intermediate output for each first processing module;
combining, during the forward pass stage of the training, intermediate outputs across the first processing modules and producing a combined intermediate output for each first processing module;
processing, during the forward pass stage of the training, combined intermediate outputs through the second processing modules of the processing engines and producing a final output for each second processing module;
determining, during backward pass stage of the training, gradients for each second processing module based on corresponding final outputs and corresponding ground truths;
accumulating, during the backward pass stage of the training, the gradients across the second processing modules and producing accumulated gradients; and
updating, during the backward pass stage of the training, weights of the second processing modules based on the accumulated gradients and producing updated second processing modules.

2. The computer-implemented method of claim 1, further including:
determining, during the backward pass stage of the training, gradients for each first processing module based on the combined intermediate outputs, the corresponding final outputs, and the corresponding ground truths; and
updating, during the backward pass stage of the training, weights of the first processing modules based on the determined gradients and producing updated first processing modules.

3. The computer-implemented method of claim 2, further including:
storing the updated first processing modules and the updated second processing modules as updated processing engines; and
making the updated processing engines available for inference.

4. The computer-implemented method of claim 1, wherein the hardware module is a computing device and/or edge device.

5. The computer-implemented method of claim 1, wherein the hardware module is a chip.

6. The computer-implemented method of claim 1, wherein the hardware module is a part of a chip.

7. The computer-implemented method of claim 1, further including accumulating the gradients across the second processing modules and producing the accumulated gradients by determining weighted averages of the gradients.

8. The computer-implemented method of claim 1, further including accumulating the gradients across the second processing modules and producing the accumulated gradients by determining averages of the gradients.

9. The computer-implemented method of claim 1, further including combining the intermediate outputs across the first processing modules and producing the combined intermediate output for each first processing module by concatenating the intermediate outputs across the first processing modules.

10. The computer-implemented method of claim 1, further including combining the intermediate outputs across the first processing modules and producing the combined intermediate output for each first processing module by summing the intermediate outputs across the first processing modules.

11. The computer-implemented method of claim 1, wherein the inputs processed through the first processing modules of the processing engines are a subset of features selected from a plurality of training examples in a training set.

12. The computer-implemented method of claim 11, wherein the inputs processed through the first processing modules of the processing engines are a subset of the plurality of the training examples in the training set.

13. The computer-implemented method of claim 1, further including:
selecting and encoding inputs for a particular first processing module based at least on an architecture of the particular first processing module and/or a task performed by the particular first processing module.

14. The computer-implemented method of claim 1, further including:
using parallel processing for performing the training of the plurality of processing engines.

15. The computer-implemented method of claim 1, wherein the first processing modules have different architectures and/or different weights.

16. The computer-implemented method of claim 1, wherein the second processing modules are copies of each other such that they have a same architecture and/or same weights.

17. A system for aggregating feature spaces from disparate data silos to execute joint prediction tasks, comprising:
a plurality of prediction engines, respective prediction engines in the plurality of prediction engines having respective encoders and respective decoders;
a plurality of data silos, respective data silos in the plurality of data silos having respective feature spaces that have input features for an overlapping population that spans the respective feature spaces;
a bus system connected to the plurality of prediction engines and configurable to partition the respective prediction engines into respective processing pipelines, and block input feature exchange via the bus system between an encoder within a particular processing pipeline and encoders outside the particular processing pipeline;
a memory access controller connected to the bus system and configurable to confine access of the encoder within the particular processing pipeline to input features of a feature space of a data silo allocated to the particular processing pipeline, and to allow access of a decoder within the particular processing pipeline to encoding generated by the encoder within the particular processing pipeline and to encodings generated by the encoders outside the particular processing pipeline; and
a joint prediction generator connected to the plurality of prediction engines and configurable to process input features from the respective feature spaces of the respective data silos through the respective encoders of corresponding allocated processing pipelines to generate respective encodings, to combine the respective encodings across the allocated processing pipelines to generate combined encodings, and to process the combined encodings through the respective decoders to generate a unified prediction for members of the overlapping population.

18. A system, comprising:
a joint prediction generator connected to a plurality of prediction engines having respective encoders and respective decoders that are configurable to process input features from respective feature spaces of respective data silos through the respective encoders to generate respective encodings, to combine the respective encodings to generate combined encodings, and to process the combined encodings through the respective decoders to generate a unified prediction for members of an overlapping population that spans the respective feature spaces.

19. A system for aggregating feature spaces from disparate data silos to execute joint training tasks, comprising:
a plurality of prediction engines, respective prediction engines in the plurality of prediction engines having respective encoders and respective decoders configurable to generate gradients during training;
a plurality of data silos, respective data silos in the plurality of data silos having respective feature spaces that have input features for an overlapping population that spans the respective feature spaces, the input features configurable as training samples for use in the training;
a bus system connected to the plurality of prediction engines and configurable to partition the respective prediction engines into respective processing pipelines, and block training sample exchange and gradient exchange via the bus system during the training between an encoder within a particular processing pipeline and encoders outside the particular processing pipeline;
a memory access controller connected to the bus system and configurable to confine access of the encoder within the particular processing pipeline to input features of a feature space of a data silo allocated as training samples to the particular processing pipeline and to gradients generated from the training of the encoder within the particular processing pipeline, and to allow access of a decoder within the particular processing pipeline to gradients generated from the training of the decoder within the particular processing pipeline and to gradients generated from the training of decoders outside the particular processing pipeline; and
a joint trainer connected to the plurality of prediction engines and configurable to process, during the training, input features from the respective feature spaces of the respective data silos through the respective encoders of corresponding allocated processing pipelines to generate corresponding encodings, to combine the corresponding encodings across the processing pipelines to generate combined encodings, to process the combined encodings through the respective decoders to generate respective predictions for members of the overlapping population, to generate a combined gradient set from respective gradients of the respective decoders generated based on the respective predictions, to generate respective gradients of the respective encoders based on the combined encodings, to update the respective decoders based on the combined gradient set, and to update the respective encoders based on the respective gradients.

20. A system, comprising:
a joint trainer connected to a plurality of prediction engines have respective encoders and respective decoders that are configurable to process, during training, input features from respective feature spaces of respective data silos through the respective encoders to generate respective encodings, to combine the respective encodings across encoders to generate combined encodings, to process the combined encodings through the respective decoders to generate respective predictions for members of an overlapping population, to generate a combined gradient set from respective gradients of the respective decoders generated based on the respective predictions, to generate respective gradients of the respective encoders based on the combined encodings, to update the respective decoders based on the combined gradient set, and to update the respective encoders based on the respective gradients.
